(19) United States
(12) Patent Application Publication
(10) Pub. No.: US 2004/0076783 A1
(43) Pub. Date: Apr. 22, 2004

(54) Corrugated liquid and vapor carrying fuel tubes and method

(76) Inventors: Andrew Norman, Paris, TN (US); F. Russell Williams, Jackson, TN (US); Christopher W. Smith, Lexington, TN (US); Willett Coffman, Lexington, TN (US); Keith S. Mizen, Beech Bluff, TN (US)

Correspondence Address: DAYCO PRODUCTS, LLC, 1 PRESTIGE PLACE, MIAMISBURG, OH, 45342, US

(21) Appl. No.: 10/277,421

(22) Filed: Oct. 22, 2002

(51) Int. Cl. B32B 1/08

(52) U.S. Cl. 428/36.91; 264/325

(57) ABSTRACT

A fuel transport tube having a corrugated or convoluting structure containing a plurality of alternating crests and valleys interconnected by shallow angled side walls wherein the crests extend radially outward from an outer surface of the fuel transport tube, the fuel transport tube comprising an inner conductive acrylonitrile-butadiene rubber layer containing carbon black; a fluorothermoplastic barrier layer comprising a tetrafluoroethylene-hexafluoropropylene-vinylidene fluoride terpolymer or a blend of fluorointerpolymers wherein at least one of the interpolymers exhibits fluorothermoplastic characteristics; an elastomeric acrylonitrile-butadiene rubber backing layer, and a chloropolyethylene cover layer.

### FIELD OF THE INVENTION

The present invention relates generally to rubber tubes and particularly to fuel transport tubes such as fuel filler tubes, fuel vent tubes and fuel filler neck tubes. More particularly, this invention relates to multi-layer tubes having a corrugated structure for use as automobile fuel tubes, and to a method for manufacturing such corrugated tubes.

### BACKGROUND OF THE INVENTION

Fuel tubes and particularly fuel transport tubes located between the fuel filler port and the fuel tank of an automobile are generally constructed of materials which exhibit reduced permeability to fuel vapors. For example, commonly assigned U.S. Pat. No. 6,203,873 to Shifman, et al discloses fuel transport hoses manufactured from a blend of a first fluorointerpolymer having elastomer characteristics and a second fluorointerpolymer having thermoplastic characteristics. Such tubes not only meet the low permeability standard for fuel vapor, but also are relatively inexpensive to produce, exhibit good service life, seal well, have good low temperature properties and good push-on values. While the tubes disclosed by Shifman resist kinking and wrinkling while being formed in conventional molding techniques, the finished tubes have relatively limited flexibility.

Since the materials commonly used to produce fuel tubes have such limited flexibility, any bending of the tube, particularly if it is a straight tube, to make the tube fit during installation will inevitably result in kinks which block the fuel path. One way of getting around the problem to pre-form the hose to take on the very complex configurations due to the multiple bends of varying degrees and curvatures necessary to conform to the limited space available. A customary method of producing this type of tube is to extrude an uncured tube onto a pin or mandrel which has the configuration of the desired finished hose. The loaded mandrel is then placed in a vulcanizer, where the tube is vulcanized or cured. The vulcanized or cured tube retains the desired shape upon removal from the pin or mandrel and is then ready to be installed in an automobile. A particular disadvantage of pre-forming the tube is that the loading of the uncured tube onto the mandrel or pin and the unloading of the cured tube from the mandrel or pin often introduces stress forces at the bends of the tube causing the formation of tears or holes in the inner wall of the finished tube.

Another way of getting around the problem is to provide the tube with a corrugated structure, provided the materials used are adaptable to being corrugated. Corrugated hoses are known, and such hoses have been used for many years on vacuum cleaners. These vacuum cleaner hoses may or may not be reinforced with a spiral-shaped, metal reinforcing wire. Such corrugated vacuum cleaner hoses are disclosed, for example, in U.S. Pat. No. 4,490,200 to Dillon; U.S. Pat. No. 5,927,757 to Keith; and U.S. Pat. No. 6,142,188 to Schaerfl.

Hoses of a double tube construction in which at least one of the tubes includes a bellows type configuration have been developed. For example, Japanese Examined Utility Model Publication (KOKOKU) No.1-31839 discloses a flexible tube which includes a bellows-like metallic flexible tube and a plastic outer tube wherein the two tubes are joined closely at their ends; Japanese Unexamined Utility Model Publication (KOKAI) No.58-42484 discloses a flexible double tube structure which includes a bellows-like outer tube and a bellows-like inner tube disposed concentrically in the outer tube, and the corrugations of the inner tube is smaller than the corrugations of the outer tube; and Japanese Unexamined Utility Model Publication (KOKAI) No. 50-80621 discloses an automobile fuel filler hose which includes a straight tube-shaped guide hose and a bellows-like tubular protector hose covering the outer periphery of the guide hose. Therefore, it is desirable to provide fuel tubes which are free from the above disadvantages. The above-referenced Japanese Examined/Unexamined Utility Model Publications were disclosed and cited in U.S. Pat. No. 5,829,483 to Tukahara, et al. Also, U.S. Pat. No. 5,829,483 to Tukahara, et al. discloses fifteen separate embodiments wherein a hose comprises a rubber outer hose member having an outer end and an inner hose formed of a resin, the inner hose being coaxially disposed in the outer member. The two hoses are sealed to form a tubular air layer between the outer rubber layer and the inner resin layer.

The prior multiple individual hose constructions taught by the prior art may give rise to inadequate sealing between the outer and inner layers. Furthermore, the construction of such hoses requires the production of multiple individual hoses and the additional steps required to adequately mate the inner hose with the outer layer in a concentrically manner and seal them together. Accordingly, it is desired to provide a single tubular construction which has satisfactory anti-flammability, is capable of preventing fuel permeation, and is sufficiently flexible to be installed in an automobile without requiring that the tubular structure be pre-formed in a particular shape.

### BRIEF SUMMARY OF THE INVENTION

It is a primary object of the present invention to provide fuel tubes and particularly fuel transport tubes which are constructed from materials typically used in the construction of such fuel tubes and yet permits the manufacture of such tubes without the disadvantages of the prior art.

Environmental regulations imposed on the automobile industry limit the amount of fuel vapor that can permeate from the fuel system of a motor vehicle. Choosing the right polymer to provide high performance, long service life, and reduced permeability of fuel, while maintaining costs at an acceptable level has been more difficult for automobile designers than ever before. Typically, fuel transfer and fuel vapor tubes have been made of butadiene-acrylonitrile rubber as the tube, but such tubes have a high permeability to fuel. Other tubes are manufactured using fluoroelastomer as the inner wall of the tube, but such tubes have higher permeability to fuel vapor. Attempts to produce fuel transfer tubes with reduced permeation to both liquid and vapor have included the use of corrugated polyamide and fluorocarbon thermoplastic tubes.

In accordance with the invention, a singular tubular member for transporting liquid and vapor fuel wherein the tubular structure prevents or significantly reduces the permeation of fuel vapor is provided. The tubular member has a corrugated or convoluted structure which exhibits the strength necessary to perform as a fuel tube, and is significantly flexible enough to be produced without having to be formed in a pre-determined shape.

The corrugated or convoluted tube of the present invention is manufactured from a material or materials which can be readily formed in a corrugated or convoluted configuration, and which meets the current standards for permeability of fuel vapor, and has satisfactory anti-flammability characteristics.

In a preferred embodiment of the invention, the tubular structure is a multi-layered structure comprising an inner conductive nitrile-butadiene rubber (NBR), a tetrafluoroethylene-hexafluoropropylene-tetrafluorovinylidene (THV) interpolymer layer surrounding the outer surface of the inner conductive NBR layer, a second NBR backing layer circumferentially adjacent the outer surface of the THV layer, and a protective cover layer on the outer surface of the second NBR backing layer.

### BRIEF DESCRIPTION OF THE DRAWING

FIG. 1 illustrates a fragmentary perspective view of a multiple layer tube construction according to a preferred embodiment of the invention, with the various layers of the tube broken away for purposes of illustration; and

FIG. 2 illustrates a mandrel for forming the corrugated tube of FIG. 1.

### DETAILED DESCRIPTION OF THE INVENTION

In accordance with the invention, a fuel tube such as a fuel transport tube, a fuel filler tube, a fuel vent tube is characterized as being corrugated or convoluted on at least a portion of the tubular structure to provide flexibility thereto so that the tube does not have to be pre-formed in a particular shape to be installed in an automobile. The corrugation or convolution configuration in the tube allows the flexible tube to be easily bent or configured to fit in the allowed space without requiring the additional step of pre-forming the tube in the manufacturing process. The alternating crests of the corrugated tube extend outwardly about 0.1 to 1.0 inch from the outer surface of the tube.

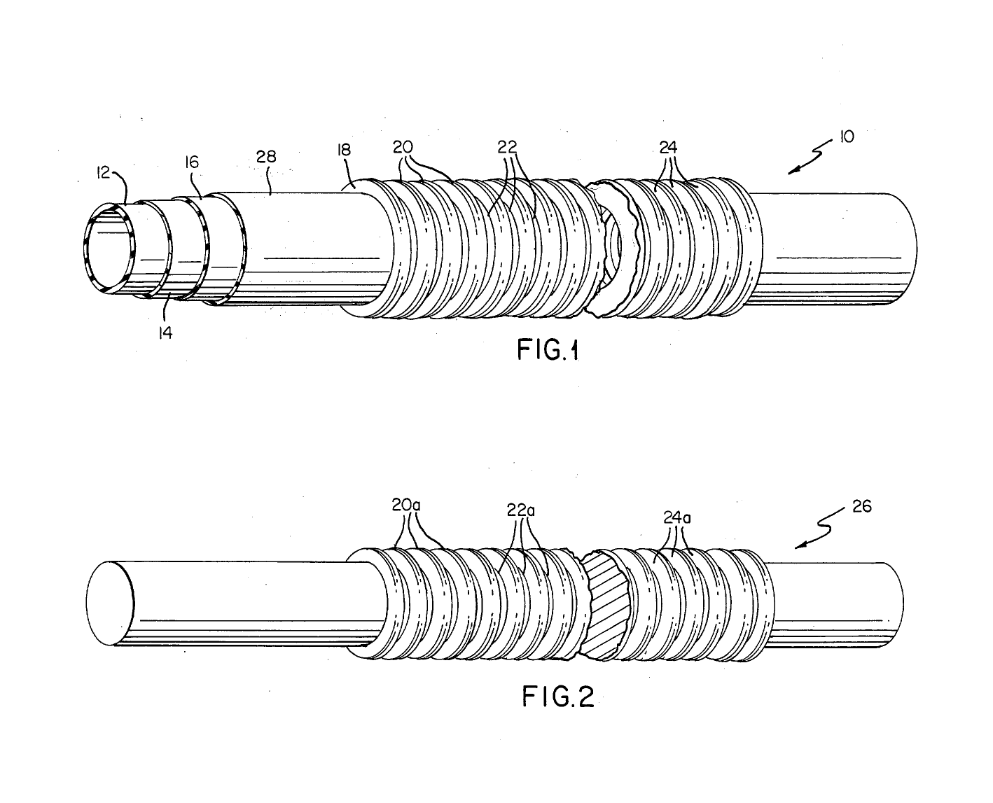

As illustrated in FIG. 1, the tube of the present invention contains four layers of materials shown as a conductive inner layer 12, a barrier layer 14, an elastomeric backing layer 16 and a cover layer 18. It is further illustrated in the FIG. 1 that the tube exhibits a number of corrugations or convolutions having alternating crests 20 and valleys 22 interconnected by shallow angled side walls 24. These corrugations or convolutions provide a certain amount of flexibility to the tube so that the tube can be easily bent and shaped into various configurations. As is typical with corrugations, the strength of the tubular structure in the corrugated region is at least as great as the strength in the non-corrugated regions.

The tube 10 is formed by placing the uncured tubular structure onto a corrugated pin (FIG. 2) which has crests 20a, valleys 22a interconnected by angled side walls 24a built into the mandrel 26. The tube on the mandrel is then subjected to a curing process causing the cured tube to exhibit corrugations or convolutions.

It has been found through strenuous testing that the corrugated or convoluted tube structure has similar properties to that of standard cured fuel tube products.

Referring again to the FIG. 1, the tube 10 of the present invention includes an inner most layer 12 which forms the inner most wall of the tube. Preferably, the inner most layer 12 is a nitrile rubber, a thermoplastic fluoroelastomer, such as hexafluoropropylene-vinylidene fluoride or hexafluoropropylene-vinylidene fluoride-tetrafluoroethylene terpolymers, polyvinyl chloride, and blends thereof. Most preferably, the inner most tubular layer 12 is an elastomeric nitrile rubber such as nitrile-butadiene rubber (NBR) layer. As is common practice in the industry, the inner most layer 12 is made conductive to prevent buildup of static electricity generated by the flow on fuel along the inner surface of the tube. Such buildup of static electricity over time has been known to cause the formation of pin holes in the tube allowing the fuel to leak out through the holes. Typically, the inner most layer 12 is made conductive by compounding any of the commonly known conducting agents into the material used to form the inner most layer. While carbon black is the preferred conductive agent it will be recognized that any of the known conducting agents may be used to provide conductivity of the inner most elastomeric layer. The amount of conducting agent added is not particularly critical, excess of some conducting agents such as carbon black tends to make the material more difficult to process. In vapor or vent applications, the inner most layer of the tube need not be conductive.

The barrier layer 14 is preferably formed from a fluorothermoplastic terpolymer such as a tetrafluoroethylene-hexafluoropropylene-vinylidene fluoride terpolymer. Typically, the fluorothermoplastic terpolymer has a fluoride content of about 70 to 75% by weight. A tetrafluoroethylene-hexafluoropropylene-vinylidene fluoride terpolymer such as Dyneon THV, commercially available from Dyneon, has been found to provide good results.

Blends of at least two fluorointerpolymers wherein at least one of the fluorointerpolymers is characterized as a fluorothermoplastic may also be employed as the barrier layer 14. Typically, the blend contains about 20 to 80% by weight of one or more fluorointerpolymers having thermoplastic characteristics blended without about 80 to 20% by weight of one or more fluorointerpolymers having elastomeric characteristics. For example, the blend of fluorointerpolymers may contain a fluorothermoplastic terpolymer comprising tetrafluoroethylene-hexafluoropropylene-vinylidene fluoride blended with a fluoroelastomeric copolymer or terpolymer containing tetrafluoroethylene, hexafluoropropylene, and/or vinylidene fluoride. Preferably, when a blend is employed, as the barrier layer 14, the fluoroplastic component of the blend is a tetrafluoroethylene-hexafluoropropylene-vinylidene terpolymer and the fluoroelastomeric component of the blend is a hexafluoropropylene-vinylidene fluoride copolymer or a vinylidene fluoride-hexafluoropropylene-tetrafluoroethylene terpolymer. Preferably, the fluoroelastomeric component has a chlorine content of about 65 to 73%. The hexafluoropropylene-vinylidene fluoride fluoroelastomer is commercially available from DuPont under the name Viton A, Viton E45 or Viton 60. The vinylidene fluoride-hexafluoropropylene-tetrafluoroethylene fluoroelastomer is commercially available from 3M under the name Fluorel FT 2350 or FE 5830QD.

The elastomeric backing layer 16 is typically a material which has properties causing it to easily adhere to both an outer cover layer and to the barrier THV layer, particularly when vulcanized. Preferably, the tubular backing layer 16 is an elastomer which affords heat resistance, fuel resistance and flexibility to the hose. Such elastomeric materials are known in the art. Elastomeric layer 16 typically is a non-conductive material selected from the group consisting of butadiene-acrylonitrile rubber, epichlorohydrin rubber, ethylene-acrylate rubber, and the like. Preferably, the elastomeric layer 16 is butadiene-acrylonitrile rubber.

The outer cover 18 of the hose is a protective layer of any of the commercially recognized materials for such use such as elastomers, thermoplastic polymers, thermosetting polymers, and the like. Typically, the protective layer 18 is a synthetic elastomer having good heat resistance, oil resistance, weather resistance and flame resistance. Preferably, the outer cover 18 is a synthetic elastomer selected from the group consisting of styrene-butadiene rubber (SBR); butadiene-nitrile rubber (NBR) such as butadiene-acrylonitrile rubber; chlorinated polyethylene; vinylethylene-acrylic rubber; acrylic rubber; epichlorohydrin rubber such as Hydrin 200; a copolymer of epichlorohydrin and ethylene oxide available from DuPont; polychloroprene rubber (CR); polyvinyl chloride; ethylene-propylene copolymers; ethylene-propylene-diene terpolymer (EPDM); ultra high molecular weight polyethylene; and blends thereof. In a preferred aspect of the invention the synthetic elastomer is chloropolyethylene.

The tubular structure of the invention may further contain a reinforcing layer 28 which affords physical strength to the finished tube. Typically, the reinforcing layer is a material selected from the group consisting of glass fibers, cotton fibers, polyamide fibers, polyester fibers, and rayon fibers. Preferably, the reinforcing layer is an aromatic polyamide such as Kevlar or Nomex, both of which are manufactured by DuPont. The reinforcing layer may be knitted, braided or spiraled to form the reinforcing layer. In a preferred aspect of the invention, the reinforcing layer is spiraled. Typically, the reinforcing layer is disposed between the barrier THV layer 14 and the elastomeric backing layer 16, or between the elastomeric backing layer 16 and the cover layer 18; however, it may also be placed between the conductive layer 12 and the THV barrier layer. Under certain conditions, more than one reinforcing layer may be used. While the reinforcing layer may be a preferred component of the tube structure, it is not critical and may or may not be used in the manufacture of certain tubes depending upon the requirements of the manufacturer.

The tubular structure 10 of the invention may be vulcanized using any of the art established vulcanizing agents such as peroxides, polyols, polyamines, etc. The peroxide vulcanizing agents includes, for example, dicumylperoxide, 2,5-dimethyl-2,5-di(t-butylperoxy) hexyne-3, etc. The polyol vulcanizing agents includes, e.g., hexafluoroisopropylidene-bis(4-hydroxyphenyl) hydroquinone, isopropylidene-bis(4-hydroxyphenyl) hydroquinone, or the like. The polyamine vulcanizing agent includes hexamethylenediamine carbamate, alicyclic diamine carbamate, etc. The amount of vulcanizing agent employed is generally that which is customarily used in the art. Typically about 0.5 to 10% vulcanizing agent is employed depending on the vulcanizing agent.

Having described the invention in detail and by reference to preferred embodiments thereof, it will be apparent that modifications and variations are possible without departing from the scope and spirit of the invention defined in the appended claims.

What is claimed is:

1. A tubular structure for use as a fuel transport tube in an automobile said tubular structure comprising:
an inner conductive layer;
a barrier layer;
a backing layer; and
a cover layer, wherein said tubular structure exhibits a corrugated or convoluted structure on at least a portion of the outer surface of the tubular structure.

2. The tubular structure of claim 1 wherein said corrugated or convoluted structure is characterized as having alternating crests and valleys interconnected by shallow angled side walls extending outwardly from the outer surface of the tube.

3. The tubular structure of claim 1 wherein said tubular structure exhibits a plurality of corrugations or convolutions on the outer surface of said tubular surface.

4. The tubular structure of claim 2 wherein said alternating crests extend radially outward about 0.1 to 1.0 inch from the outer surface of the tube.

5. The tubular structure of claim 1 wherein said inner conductive layer comprises a nitrile rubber, a thermoplastic, polyvinyl chloride, and blends thereof.

6. The tubular structure of claim 5 wherein said inner conductive layer is acrylonitrile-butadiene rubber.

7. The tubular structure of claim 1 wherein said conductive layer further contains a conductive material.

8. The tubular structure of claim 7 wherein said conductive material is carbon black.

9. The tubular structure of claim 1 wherein said barrier layer is a tetrafluoroethylene-hexafluoropropylene-vinylidene fluoride terpolymer, said tetrafluoroethylene-hexafluoropropylene-vinylidene fluoride terpolymer exhibiting fluorothermoplastic characteristics.

10. The tubular structure of claim 9 wherein said tetrafluoroethylene-hexafluoropropylene-vinylidene fluoride terpolymer has a chlorine content of about 70 to 75% by weight.

11. The tubular structure of claim 1 wherein said barrier layer comprises a blend of at least two fluorointerpolymers wherein at least one of the fluorointerpolymers is characterized as a fluorothermoplastic.

12. The tubular structure of claim 11 wherein said barrier layer comprises about 20 to 80% by weight of a first fluorointerpolymer having fluorothermoplastic characteristics blended with about 80 to 20% by weight of a second fluorointerpolymer having fluoroelastomeric characteristics.

13. The tubular structure of claim 12 wherein said first fluorointerpolymer is a fluorothermoplastic terpolymer comprising tetrafluoroethylene-hexafluoropropylene-vinylidene fluoride and said second interpolymer is a fluoroelastomeric copolymer or terpolymer containing two or more of tetrafluoroethylene, hexafluoropropylene and vinylidene fluoride.

14. The tubular structure of claim 13 wherein said first fluorothermoplastic terpolymer has a fluorine content of about 70 to 75% by weight and said second fluoroelastomeric copolymer or terpolymer has fluorine content of about 65 to 73% by weight.

15. The tubular structure of claim 1 wherein said elastomeric backing layer is a synthetic elastomer selected from the group consisting of styrene-butadiene rubber, butadiene-acrylonitrile rubber, chlorinated polyethylene, vinylethylene-acrylic rubber, acrylic rubber, epichlorohydrin rubber, a copolymer of epichlorohydrin and ethylene oxide, polychloroprene rubber, polyvinyl chloride, ethylene-propylene copolymers, ethylene-propylene-diene terpolymer, ultra high molecular weight polyethylene, and blends thereof.

16. The tubular structure of claim 15 wherein said elastomeric backing layer is acrylonitrile-butadiene rubber.

17. The tubular structure of claim 1 wherein said cover layer is a synthetic elastomer selected from the group consisting of styrene-butadiene rubber, butadiene-nitrile rubber, chlorinated polyethylene, vinylethylene-acrylic rubber, acrylic rubber, epichlorohydrin rubber, polychloroprene rubber, polyvinyl chloride, ethylene-propylene copolymers, ethylene-propylene-diene terpolymer, ultra high molecular weight polyethylene, and blends thereof.

18. The tubular structure of claim 17 wherein said synthetic elastomer is chloropolyethylene.

19. The tubular structure of claim 1 further comprising at least one reinforcing layer.

20. The tubular structure of claim 19 wherein said at least one reinforcing layer comprises glass fibers, cotton fibers, polyamide fibers, polyester fibers, and rayon fibers.

21. The tubular structure of claim 19 wherein said at least one reinforcing layer is composed of spirals of an aromatic polyamide.

22. The tubular structure of claim 19 wherein said at least one reinforcing layer is between said barrier layer and said elastomeric backing layer.

23. The tubular structure of claim 19 wherein said at least one reinforcing layer is between said elastomeric backing layer and said cover layer.

24. A fuel transport tube exhibiting a corrugated or convoluting structure containing a plurality of alternating crests and valleys interconnected by shallow angled side walls wherein said crests extend radially outward from an outer surface of said fuel transport tube, said fuel transport tube comprising:
an inner conductive acrylonitrile-butadiene rubber layer containing carbon black;
a fluorointerpolymer barrier layer having a fluorine content of about 70-75% by weight, said fluorointerpolymer barrier layer comprising a tetrafluoroethylene-hexafluoropropylene-vinylidene fluoride terpolymer, said tetrafluoroethylene-hexafluoropropylene-vinylidene fluoride terpolymer exhibiting fluorothermoplastic characteristics;
an elastomeric acrylonitrile-butadiene rubber backing layer; and
a chloropolyethylene cover layer.

25. The fuel transport tube of claim 24 further comprising at least one reinforcing layer.

26. The fuel transport tube of claim 25 wherein said at least one reinforcing layer is a spiraled aromatic polyamide disposed between said conductive layer and said barrier layer or between said barrier layer and said cover layer.

27. A method of producing a corrugated or convoluted fuel transport tube comprising:
providing a mandrel having a plurality of alternating crests and valleys thereon wherein said alternating crests and valleys are interconnected by a plurality of shallow angled side walls;
providing an uncured multi-layered tubular structure;
pushing said uncured multi-layered tubular structure onto said mandrel to provide a tubular structure exhibiting a corrugated or convoluted configuration corresponding to the corrugated or convoluted configuration of said mandrel;
vulcanizing said multi-layered structure on said mandrel; and
removing said vulcanized multi-layered tubular structure exhibiting said corrugated or convoluted configuration from said mandrel, said corrugated or convoluted tubular structure having a plurality of alternating crests and valleys extending radially outward from an outer surface of said tubular structure.

28. The method of claim 27 wherein said alternating crests on said mandrel extend radially outward about 0.1 to 1.0 inch from the outer surface of said mandrel.

29. The method of claim 27 wherein said multi-layered structure comprises:
an inner conductive acrylonitrile-butadiene rubber layer containing carbon black;
a fluorointerpolymer barrier layer having a fluorine content of about 70-75% by weight, said fluorointerpolymer barrier layer comprising a tetrafluoroethylene-hexafluoropropylene-vinylidene fluoride terpolymer, said tetrafluoroethylene-hexafluoropropylene-vinylidene fluoride terpolymer exhibiting fluorothermoplastic characteristics;
an elastomeric acrylonitrile-butadiene rubber backing layer; and
a chloropolyethylene cover layer.

30. The method of claim 29 further comprising at least one reinforcing layer.

31. The method of claim 30 wherein said at least one reinforcing layer is a spiraled aromatic polyamide disposed between said conductive layer and said barrier layer or between said barrier layer and said cover layer.
